(19) United States
(12) Patent Application Publication
(10) Pub. No.: US 2024/0367375 A1
(43) Pub. Date: Nov. 7, 2024

(54) Printing System and Use of a Printing System

(71) Applicant: Putzmeister Engineering GmbH, Aichtal (DE)

(72) Inventors: Knut KASTEN, Ostfildern (DE); Tobias HUTH, Stuttgart (DE); Hans-Bernd DUERR, Herrenberg (DE)

(21) Appl. No.: 18/565,371

(22) PCT Filed: May 30, 2022
(86) PCT No.: PCT/EP2022/064561

§ 371 Date: Nov. 29, 2023

(30) Foreign Application Priority Data
May 31, 2021 (DE) 10 2021 205 514.1

(51) Int. Cl. B29C 64/241; B29C 64/209; B29C 64/321; B29C 64/393; B33Y 10/00; B33Y 30/00; B33Y 50/02; E04G 21/04

(52) U.S. Cl. CPC B29C 64/241; B29C 64/209; B29C 64/321; B29C 64/393; E04G 21/0436; E04G 21/0463; B33Y 10/00; B33Y 30/00; B33Y 50/02

(57) ABSTRACT

A printing system for forming a strand of construction material for 3D printing of a construction part includes a printing head, a parallel robot, in particular a delta robot, and a coarse movement device. The printing head is designed to discharge construction material out of the printing system and to shape the construction material to form the strand of construction material. The parallel robot has at least three robot arm devices for fine positioning of the printing head with respect to the coarse movement device. At least the two closest of the robot arm devices are mutually offset in a circumferential direction about a central axis of the parallel robot by an obtuse arc angle. The coarse movement device is designed for a coarse movement of the parallel robot together with the printing head.

### FIELD OF APPLICATION

The invention relates to a printing system for forming a strand of building material for 3-D printing of a structural part and to the use of such a printing system for forming a strand of building material for 3-D printing of a structural part.

### BACKGROUND AND SUMMARY

The problem addressed by the invention is that of providing a printing system for forming a strand of building material for 3-D printing of a structural part, which printing system has improved characteristics. Moreover, the problem addressed by the invention is that of providing the use of such a printing system for forming a strand of building material for 3-D printing of a structural part.

The invention solves this problem through the provision of a printing system and its use thereof in accordance with the independent claims. Advantageous developments and/or embodiments of the invention are described in the dependent claims.

The printing system according to the invention is designed for forming, in particular automatically forming, a strand of building material for 3-D printing of a structural part, in particular a three-dimensional structural part. The printing system comprises a printing head, a parallel robot, more particularly a delta robot, and a coarse movement device. The printing head is designed for the delivery, in particular the automatic delivery, of building material from the printing system and for shaping, in particular automatic shaping, of building material for forming the strand of building material. For fine positioning or movement, in particular for automatic fine positioning or movement, of the printing head in relation to the coarse movement device, especially during the delivery and/or the shaping of building material, the parallel robot comprises at least three robot arm devices. At least two robot arm devices closest to one another are offset from one another, in particular arranged, with an oblique angle of arc along a circumferential direction about a central axis of the parallel robot. The coarse movement device is designed for coarse movement or positioning, in particular automatic coarse movement or positioning, of the parallel robot with the printing head, especially during the delivery and/or the shaping of building material.

This, the parallel robot in particular, enables a compensation, in particular a fast compensation, or a correction, in particular a fast correction, of a positioning or targeting inaccuracy of the coarse movement device. Thus, this allows a positionally accurate or pinpoint or precise and/or fast formation of the strand of building material for 3-D printing of the structural part. As an addition or alternative, this, the oblique angle of arc in particular, provides good accessibility to the central axis.

In particular, the strand, in particular the delivered and/or shaped strand, may be continuous or extend along a length, in particular a certain length.

The building material may be concrete, in particular fresh concrete, and/or thixotropic and/or set or dimensionally stable, especially during the delivery.

3-D printing can be referred to as additive manufacturing. As an addition or alternative, the strand may be deposited or applied, in particular in layers, on or to an already formed strand, and/or a further strand may be deposited or applied, in particular in layers, on or to the strand.

The structural part may be a building structural part and/or a wall and/or a ceiling. As an addition or alternative, the strand, in particular a width of the strand, may have the thickness, in particular the entire thickness, of the wall and/or ceiling.

The printing system can be an extruder system for the extrusion of the strand of building material for 3-D printing of the structural part. As an addition or alternative, the printing head can be an extruder head for the extrusion of building material from the printing system.

As a further addition or alternative, the printing head may comprise an extruder nozzle. The extruder nozzle can have a discharge opening for the discharge of building material, in particular the strand of building material, out of the printing system, in particular in a non-vertical, more particularly horizontal, discharge direction. In particular, the discharge opening may comprise or have an opening width, in particular a maximum opening width, of at least 100 mm (millimeters), in particular at least 200 mm, and/or of at most 800 mm, in particular at most 600 mm, in particular 400 mm, in particular in a first radial direction orthogonal to the discharge direction.

As a further addition or alternative, the discharge opening may comprise or have an opening height, in particular a maximum opening height, of at least 15 mm, in particular at least 25 mm, and/or of at most 400 mm, in particular at most 200 mm, in particular at most 100 mm, in particular 50 mm, in particular in a second radial direction which is orthogonal to the discharge direction.

As a further addition or alternative, the discharge opening may comprise or have a quadrangular shape, in particular a trapezoidal shape, in particular a parallelogram shape, in particular a rectangular shape.

As a further addition or alternative, a strand cross section, in particular a shape and/or a size of the strand cross section, of the strand, in particular of the delivered strand, may correspond, in particular equate, to an opening cross section, in particular a shape and/or a size of the opening cross section, of the discharge opening. As a further addition or alternative, the opening cross section of the discharge opening and/or the strand cross section of the strand may be non-parallel, in particular orthogonal, to the discharge direction.

As a further addition or alternative, the printing system may be designed for depositing the delivered strand such that the strand, in particular the deposited strand, maintains its strand cross section, in particular of the delivered strand. In other words, the printing system does not need to be designed, or cannot be designed, such that the building material needs to be, or can be, printed onto an already existing building material layer or ply and thus deformed.

The term “manipulator” and the term “robot” can be used synonymously.

The term “parallel-type robot” and the term “parallel robot” can be used synonymously. As an addition or alternative, the parallel robot can be designed for fine positioning or movement, in particular translational fine positioning or movement, and/or fine orientation or movement, in particular rotational fine orientation or movement, of the printing head in relation to the coarse movement device, in particular in a positioning direction, more particularly in a horizontal positioning direction.

As a further addition or alternative, the robot arm devices may comprise articulated arm devices, in particular be articulated arm devices. As a further addition or alternative, the robot arm devices may be linked, especially by means of cardan joints, to a base and/or a platform of the parallel robot.

As a further addition or alternative, the base of the parallel robot may be assembled above the moving parts of the parallel robot and/or the platform of the parallel robot, especially in or along a vertical direction and/or the center axis. As a further addition or alternative, the term “central axis” and the term “center axis” can be used synonymously.

As a further addition or alternative, the printing head may be arranged at least in part on the center axis and/or between the robot arm devices, in particular the three robot arm devices, and/or the base and/or the platform. As a further addition or alternative, the printing system can be designed for the rotational movement, in particular for the automatic rotational movement, of the parallel robot and printing head, in particular with its discharge opening, in particular about the center axis, especially during the delivery and/or the shaping of building material. As a further addition or alternative, the oblique angle of arc may be between a vector from the center axis to one of the robot arm devices and another or next vector from the center axis to another one or next one of the robot arm devices. As a further addition or alternative, the oblique angle of arc may be at least 105° (degrees). As a further addition or alternative, as seen along the circumferential direction about the center axis, all closest ones of the robot arm devices, in particular on a case-by-case basis, may be offset from one another by an, in particular approximately, in particular exactly, equal or equivalent oblique angle of arc. In particular, approximately equal may mean that the angles of arc may have or comprise an angle deviation of no more than 5°, in particular no more than 2.5°.

In particular, the parallel robot may carry, in particular directly carry, the printing head at its end, more particularly at its lower end. As an addition or alternative, the printing head, in particular the discharge opening thereof, may spread or extend beyond the parallel robot, in particular downwardly, especially along the vertical direction or the center axis, and/or laterally or circumferentially or forwardly, especially in or along a horizontal direction and/or the discharge direction and/or radially with respect to the center axis. As a further addition or alternative, the coarse movement device, in particular at the end thereof, may carry the parallel robot, in particular directly carry the parallel robot, which in particular carries the printing head. As a further addition or alternative, the parallel robot, in particular with the printing head, may spread or extend beyond the coarse movement device. This, in particular the extent, may allow the delivery of the strand, in particular in the horizontal discharge direction, at a relatively short distance in particular vertically above an already formed strand, in particular without damaging the latter, and thus allow the discharged strand to be deposited from a relatively low height.

The term “coarse positioning device” and the term “coarse movement device” can be used synonymously. As an addition or alternative, the coarse movement device may be designed for translational and/or rotational coarse movement of the parallel robot with the printing head, in particular in one movement direction, more particularly a horizontal movement direction. In particular, the printing head may be designed for the delivery of building material, in particular the strand of building material, from the printing system, in particular the discharge opening, in the discharge direction, which is non-orthogonal, in particular reversed, in particular opposite, to the movement direction, especially during the coarse movement.

As an addition or alternative, the printing system, in particular the printing head, may be designed for the delivery of building material, in particular the strand of building material, from the printing system, in particular the discharge opening, with an in particular variable, in particular continuously settable or adjustable discharge speed. The coarse movement device may be designed for the coarse movement of the parallel robot with the printing head at a movement speed approximately equal to the discharge speed, especially during the delivery. This, in particular the approximately equal speeds, may make it possible for the delivered and/or deposited strand to maintain its strand cross section which in particular corresponds, in particular equates, to the opening cross section. In particular, reversed can mean a minimum of 135°, in particular a minimum of 150°, in particular 165°. As an addition or alternative, opposite may mean 180°. As a further addition or alternative, approximately can mean a difference or a deviation of at most 5 percent (%), in particular of at most 2%, in particular of at most 1%.

The printing system may comprise a controlling device, in particular an open-loop and/or closed-loop control device. The controlling device may be designed for controlling, in particular automatically controlling, more particularly for open-loop and/or closed-loop control of, the printing head and/or parallel robot and/or coarse movement device, especially on the basis of data, in particular a building or construction plan, in particular stored in a memory of the controlling device, of the structural part to be printed. In particular, the controlling device may comprise a computer, more particularly be a computer. This may make it possible that a work operative need not control the printing system, and/or that errors during the construction process can be reduced or even avoided.

In a development of the invention, the printing system comprises a conveying hose, in particular a flexible conveying hose. The conveying hose leads between the two closest robot arm devices offset from one another, especially laterally or circumferentially and/or radially to the center axis, with the oblique angle of arc for guiding building material, in particular from the coarse movement device, to the printing head. This allows the delivery of building material by means of the printing head. As an addition or alternative, this is made possible by the good accessibility to the center axis. In particular, the coarse movement device, the parallel robot, and/or the printing head may carry, in particular directly carry, the conveying hose. As an addition or alternative, the conveying hose need not or cannot carry the parallel robot and/or the printing head. As a further addition or alternative, the conveying hose may be arranged in part on the center axis and/or the base and/or the platform.

As a further addition or alternative, the printing system can be designed for the rotational movement, in particular for the automatic rotational movement, of the conveying hose and printing head, in particular with its discharge opening, in particular about the center axis, especially during the delivery and/or the shaping of building material.

As a further addition or alternative, the printing head may comprise a deflection device or a deflection element. The deflection device may be arranged upstream of the discharge opening and may be designed for deflecting a flow of building material, in particular from a non-horizontal direction, more particularly a vertical direction, in particular from top to bottom, in the direction of the discharge opening, in particular in the discharge direction, in particular from back to front. This, in particular the deflection device, may allow the horizontal discharge.

In particular, the parallel robot may be a hexapod. However, the parallel robot need not be a hexapod. As an addition or alternative, the parallel robot may, but need not, comprise four or more robot arm devices.

In a development of the invention, the parallel robot, more particularly the delta robot, comprises exactly three robot arm devices. As an addition or alternative, the oblique angle of arc is approximately 120°, in particular exactly 120°. This allows a simple and hence cost-effective structure of the parallel robot. As a further addition or alternative, this allows the fine positioning of the printing head in relation to the coarse movement device in or with three, more particularly exactly three, translational degrees of freedom. As a further addition or alternative, this allows particularly good accessibility to the center axis. In particular, the term “substantially” and the term “approximately” can be used synonymously.

In a development of the invention, the parallel robot comprises electrical and/or hydraulic and/or pneumatic-free drive devices. The drive devices are designed for driving, in particular automatically driving, or moving the robot arm devices. This allows particularly fast and/or accurate fine positioning of the printing head in relation to the coarse movement device. In particular, the term “actuators” and the term “drive devices” can be used synonymously. As an addition or alternative, the base may carry, in particular directly carry, the drive devices.

In a development of the invention, the coarse movement device comprises a serial robot, in particular a distribution boom, for coarse movement of the parallel robot, in particular at a boom tip of the distribution boom, in particular with the printing head. In particular, the coarse movement device is the serial robot. This enables a great range of the coarse movement device and hence a large structural part. As an addition or alternative, this allows a space-saving and hence easily displaceable structure of the coarse movement device and/or a structure of the coarse movement device which is quickly deployable in situ and consequently promptly ready to use. As a further addition or alternative, this allows the coarse movement of the parallel robot with the printing head in or with three, more particularly exactly three, translational degrees of freedom. In particular, the term “serial-type robot” and the term “serial robot” can be used synonymously. As an addition or alternative, the parallel robot can be arranged, in particular fastened, more particularly in direct fashion, at the boom tip. As a further addition or alternative, the printing system may comprise a conveying line, in particular a conveying pipe, more particularly an inflexible conveying pipe, for guiding building material, in particular to the conveying hose. The conveying line may, at least in part, lead along the coarse movement device at least in part and/or to the conveying hose. In particular, the serial robot can carry, in particular directly carry, the conveying line. As an addition or alternative, the conveying line may carry, in particular directly carry, the conveying hose. As a further addition or alternative, the conveying line need not or cannot carry the parallel robot and/or the printing head.

In one embodiment of the invention, the serial robot comprises rotary joints, in particular only rotary joints. In particular, axes of rotation of the rotary joints are oriented or aligned parallel to one another, in particular only parallel to one another. This allows simple controlling of the coarse movement of the parallel robot with the printing head by means of the coarse movement device. As an addition or alternative, this allows a simple and hence cost-effective structure of the coarse movement device. As a further addition or alternative, this allows an orientation, in particular a non-adjustable or non-variable and/or parallel orientation, of the parallel robot and/or printing head in relation to a base, in particular a foot, of the serial robot. In particular, the axes of rotation may be horizontal, in particular aligned. As an addition or alternative, the serial robot may have an articulated-arm structure, in particular be an articulated-arm structure.

In a development of the invention, the printing system comprises an orientation device, in particular a support system. The orientation device is designed in particular for orienting, in particular automatically orienting, in particular a base, more particularly a foot, of the coarse movement device in relation to a building environment of the printing system. This allows the serial robot to be able to have rotary joints, in particular only have rotary joints. As an additional or alternative, this allows the axes of rotation to be horizontal, in particular aligned. As a further addition or alternative, this enables an alignment, in particular the alignment, of the parallel robot and/or printing head. In particular, the term “alignment” and the term “orientation” can be used synonymously. As an addition or alternative, the orientation device can carry, in particular directly carry, the coarse movement device, in particular on the base thereof.

In a development of the invention, the printing head and/or the parallel robot are/is free from an inclination degree of freedom. This allows a simple and hence cost-effective structure of the printing head and/or parallel robot. As an addition or alternative, this allows an orientation, in particular a non-adjustable or non-variable and/or parallel orientation, of the printing head and/or parallel robot in relation to the coarse movement device, in particular one end of the coarse movement device. In particular, the term “tilt” and the term “inclination” can be used synonymously.

In a development of the invention, the printing system comprises an interface for a position and/or orientation sensing or sensor device and/or the position and/or orientation sensing or sensor device, which in particular is independent of the coarse movement device and/or external. The position and/or orientation sensing device is designed for sensing a position and/or orientation quantity, in particular a dynamic position and/or orientation quantity, more particularly a value of the position and/or orientation quantity, which determines a position, in particular a translational position, more particularly a value of the position, and/or an orientation, in particular a rotational orientation, more particularly a value of the orientation, of the printing head and/or parallel robot in relation to a building environment, in particular the building environment, of the printing system. The printing system comprises a controlling device, in particular the controlling device. The controlling device is designed for controlling the parallel robot for finely positioning the printing head in relation to the coarse movement device on the basis of the sensed position and/or orientation quantity. This allows a positionally accurate formation of the strand of building material for 3-D printing of the structural part in relation to the building environment. In particular, the interface, the position and/or orientation sensing device and/or the controlling device may be electrical. As an addition or alternative, the term “detecting” and the term “sensing” can be used synonymously. As a further addition or alternative, the sensing and/or controlling may be automatic. As a further addition or alternative, the position and/or orientation quantity may be physical. As a further addition or alternative, the position may be an actual position. As a further addition or alternative, the orientation may be an actual orientation.

In particular, the position and/or orientation sensing device may comprise, more particularly be, an image processing system (e.g., a laser light section system), at least one triangulation sensor, a light barrier function, and/or at least one ultrasonic sensor.

In an embodiment of the invention, the position and/or orientation sensing device comprises a tachymeter, in particular a laser tachymeter. In particular, the position and/or orientation sensing device is a tachymeter. This allows great accuracy, in particular in the 1 mm-meter range. In particular, the tachymeter may be optical and/or electrical.

In an embodiment of the invention, the printing system comprises an inertial sensor or sensing device. The inertial sensor device comprises at least one inertial sensor. The inertial sensor is arranged, in particular fastened, more particularly in direct fashion, and designed on the printing head and/or parallel robot for sensing an inertial or movement quantity, in particular a dynamic inertial or movement quantity, more particularly a value of the inertial quantity, which determines a movement, in particular a translational and/or rotational movement, more particularly a value of the movement, of the printing head and/or parallel robot in relation to the building environment of the printing system. The controlling device is designed for controlling the parallel robot for finely positioning the printing head in relation to the coarse movement device by linking the sensed position and/or orientation quantity, which in particular was sensed at a low frequency and/or which arrives at the controlling device in particular and/or with a time offset, and the sensed inertial quantity, which in particular was sensed at a higher frequency and/or which arrives at the controlling device in particular and/or with a smaller or no time offset or without a time offset, to one another, in particular by means of an estimate, in particular by an observer. This enables an error-minimized and/or, in particular as a result, particularly accurate compensation, in particular prospectively and/or, in particular as a result, currently or in real time. In particular, the phrase “initial measuring unit” and the term “inertial sensor device” can be used synonymously.

As an addition or alternative, the inertial sensor device and/or inertial sensor may be electrical. As a further addition or alternative, the inertial sensor may comprise, in particular be, an acceleration and/or rate sensor. As a further addition or alternative, the inertial quantity may include, in particular be, an acceleration and/or rate. As a further addition or alternative, the sensing and/or linking may be automatic. As a further addition or alternative, the term “sampling rate” and the term “frequency” can be used synonymously. As a further addition or alternative, the term “fusion” and the term “link” can be used synonymously. As a further addition or alternative, the estimate may include, in particular be, an interpolation, in particular by means of a dynamic model. As a further addition or alternative, the estimate may be iterative. As a further addition or alternative, the observer may comprise, in particular be, a Kalman filter, in particular a standard or extended Kalman filter. As a further addition or alternative, the inertial sensor device may be independent of and/or external to the coarse movement device and/or the position and/or orientation sensing device.

In a development of the invention, the printing system comprises a chassis, in particular a truck-mounted building material pump comprising the chassis. The chassis carries the printing head, the parallel robot, and the coarse movement device, in particular directly. This allows a simple and/or, in particular as a result, fast transport of the printing system to a deployment location. In particular, the chassis can carry the coarse movement device, in particular directly, on the base thereof. As an addition or alternative, the chassis may carry the conveying hose, the orientation device, in particular directly, the interface, the position and/or orientation sensing device, the inertial sensor device, and/or the controlling device. As a further addition or alternative, the orientation device may carry, in particular directly carry, the chassis, in particular at the deployment location and/or for orienting the coarse movement device in relation to the building environment of the printing system.

In one refinement of the invention, the printing system has a building material pump. The building material pump is designed for conveying, in particular automatically conveying, building material, in particular at least in part along the coarse movement device, in particular for the delivery of conveyed building material, out of the printing system. In particular, the building material pump may be connected to the printing head for a flow of building material from the building material pump to the printing head, in particular by means of the conveying line and/or conveying hose. As an addition or alternative, the building material pump may be designed for conveying building material through the conveying line and/or conveying hose. As a further addition or alternative, the building material pump may be discontinuous, in particular a piston pump, in particular a two-piston pump, in particular having a pipe switch. As a further addition or alternative, the controlling device may be designed for controlling, in particular automatically controlling, more particularly for open-loop and/or closed-loop control of, the building material pump, in particular on the basis of data of the structural part to be printed. As a further addition or alternative, the chassis may carry the building material pump, in particular directly.

In a development of the invention, the printing head is designed for forming the strand of building material with a grain size or a maximum grain size of at least 2 mm, in particular at least 8 mm, and/or at most 50 mm. As an addition or alternative, the parallel robot comprises or has a payload of at least 10 kg (kilogram) and/or at most 3000 kg, in particular at most 500 kg. As a further addition or alternative, the parallel robot comprises or has a positioning accuracy of at least 50 mm and/or at most 0.1 mm, in particular at most 1 mm. As a further addition or alternative, the parallel robot comprises or has a range of at least 10 mm, in particular at least 100 mm, and/or at most 1000 mm, in particular at most 500 mm. As a further addition or alternative, the parallel robot has a maximum speed of at least 10 mm/s (millimeters per second) and/or at most 10 m/s (meters per second). As a further addition or alternative, the parallel robot comprises or has a maximum acceleration and/or deceleration of at least 0.1 m/s² (meters per second squared) and/or at most 500 m/s². As a further addition or alternative, the coarse movement device comprises or has a payload of at least 50 kg and/or at most 5000 kg. As a further addition or alternative, the coarse movement device comprises or has a positioning accuracy of at least 500 mm and/or at most 10 mm. As a further addition or alternative, the coarse movement device comprises or has a range, in particular the range, of at least 10 m (meters) and/or at most 100 m. As a further addition or alternative, the coarse movement device comprises or has a maximum speed of at least 10 mm/s and/or at most 2 m/s. As a further addition or alternative, the coarse movement device comprises or has a maximum acceleration and/or deceleration of at least 1 m/s² and/or at most 20 m/s².

Moreover, the invention relates to the use, in particular the automatic use, of a printing system, in particular the printing system, as mentioned above for forming, in particular automatically forming, a strand of building material, more particularly the strand of building material, for 3-D printing of a structural part, in particular the structural part.

Further advantages and aspects of the invention emerge from the claims and from the description of exemplary embodiments of the invention, which are discussed below on the basis of the figures.

### BRIEF DESCRIPTION OF THE DRAWINGS

FIG. 1 schematically shows a printing system according to an embodiment of the invention.

FIG. 2 schematically shows a plan view of a parallel robot of the printing system of FIG. 1.

FIG. 3 schematically shows the printing system of FIG. 1 during an exemplary use according to the invention.

FIG. 4 schematically shows a printing head and a building material pump of the printing system of FIG. 1 during the use of FIG. 3.

FIG. 5 schematically shows a structural part made of formed strands of building material and 3-D printed using the printing system of FIG. 1.

FIG. 6 schematically shows a position and/or orientation sensing device, an inertial sensor device, and a controlling device of the printing system of FIG. 1.

### DETAILED DESCRIPTION OF THE DRAWINGS

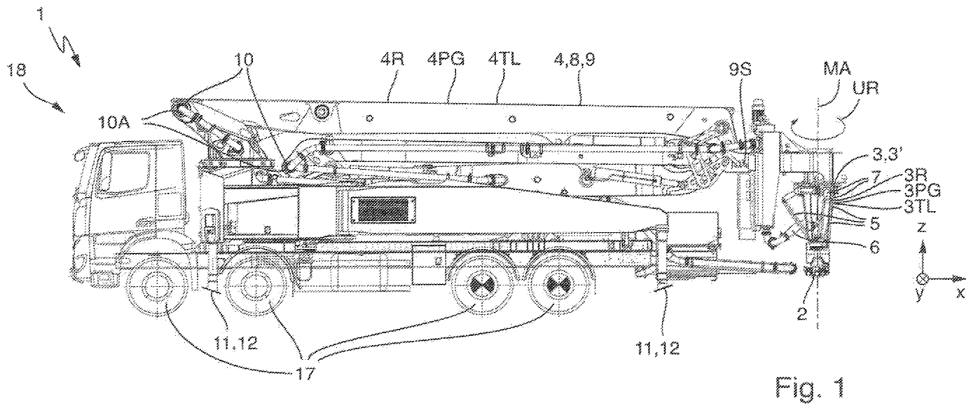

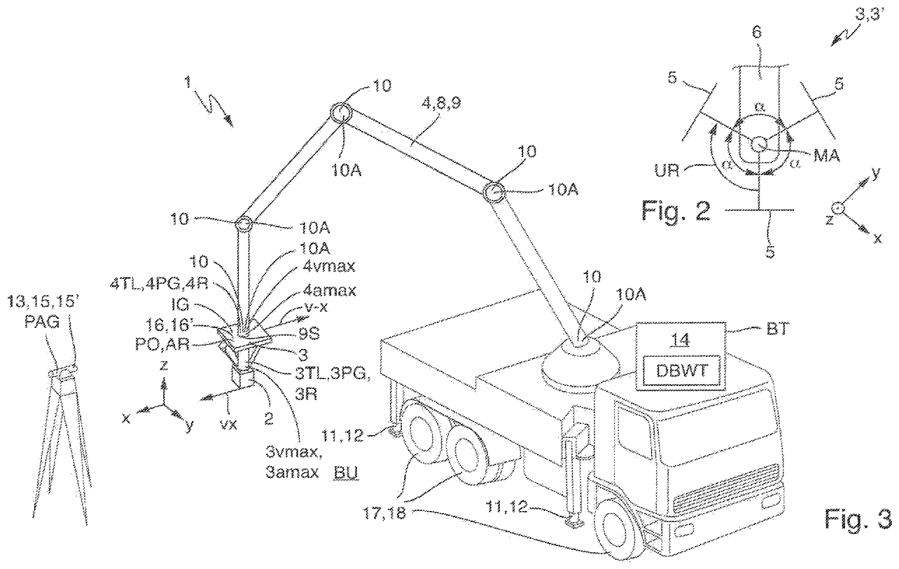

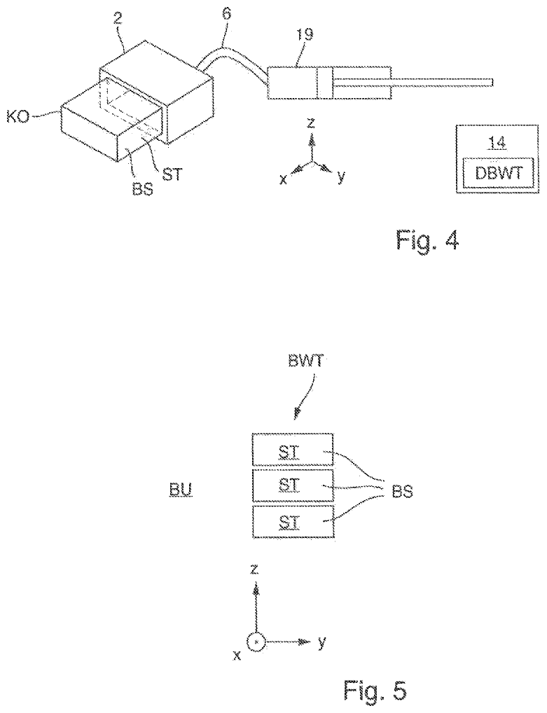

FIGS. 1 and 3 show a printing system 1 for forming, in particular during the formation of, a strand ST of building material BS for 3-D printing, in particular during the 3-D printing, of a structural part BWT as shown in FIG. 5. The printing system 1 comprises a printing head 2, a parallel robot 3, more particularly a delta robot 3′, and a coarse movement device 4. The printing head 2 is designed for the delivery of building material BS from the printing system 1 and for shaping building material BS to form the strand ST of building material BS, in particular it delivers and shapes and forms as a result, as shown in FIG. 4. The parallel robot 3 comprises at least three robot arm devices 5, as shown in FIGS. 1 and 2, for finely positioning, in particular finely positions, the printing head 2 in relation to the coarse movement device 4. At least two robot arm devices 5 closest to one another are offset from one another with an oblique angle of arc a along a circumferential direction UR about a central axis MA of the parallel robot 3. The coarse movement device 4 is designed for coarsely moving, in particular coarsely moves, the parallel robot 3 with the printing head 2.

In detail, the printing system 1 comprises a conveying hose 6. The conveying hose 6 leads between the two closest robot arm devices 5 offset from one another with the oblique angle of arc a for guiding, in particular guides, building material BS, in particular from the coarse movement device 4, to the printing head 2.

Moreover, the parallel robot 3, more particularly the delta robot 3′, comprises exactly three robot arm devices 5.

As an addition or alternatively, the oblique angle of arc a is approximately 120°, in particular exactly 120°.

Moreover, the parallel robot 3 comprises electrical and/or hydraulic and/or pneumatic-free drive devices 7, in particular in a number corresponding to, more particularly equaling, the number of robot arm devices 5; these total three in the exemplary embodiment shown. The drive devices 7 are designed for driving, in particular drive, the robot arm devices 5.

Further, the coarse movement device 4 comprises a serial robot 8, in particular a distribution boom 9, for coarse movement of the parallel robot 3, in particular at a boom tip 9S of the distribution boom 9. In particular, the coarse movement device 4 is the serial robot 8.

In detail, the serial robot 8 comprises rotary joints 10. Axes of rotation 10A of the rotary joints 10 are parallel to one another, in particular horizontal.

In the exemplary embodiment shown, the serial robot 8 comprises at least five rotary joints 10. In alternative exemplary embodiments, the serial robot may comprise at least two rotary joints.

Moreover, the printing system 1 comprises an orientation device 11, in particular a support system 12. The orientation device 11 is designed for orienting, in particular orients, especially horizontally, the coarse movement device 4 in relation to a building environment BU of the printing system 1.

Moreover, the printing head 2 and/or the parallel robot 3 are/is free from an inclination degree of freedom.

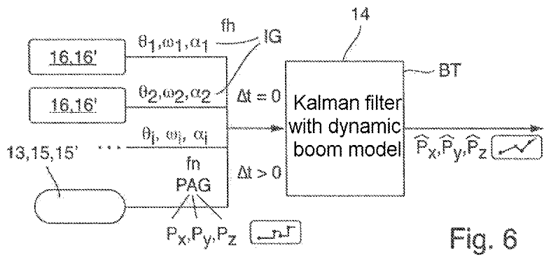

Moreover, the printing system 1 comprises an interface for a position and/or orientation sensing device 13 and/or the position and/or orientation sensing device 13, which in particular is independent of the coarse movement device 4 and/or external, as shown in FIGS. 3 and 6. The position and/or orientation sensing device 13 is designed for sensing, in particular senses, a position and/or orientation quantity PAG, in particular a dynamic position and/or orientation quantity, which determines a position PO and/or an orientation AR of the printing head 2 and/or parallel robot 3 in relation to a building environment BU of the printing system 1. The printing system 1 comprises a controlling device 14. The controlling device 14 is designed for controlling, in particular controls, the parallel robot 3 for finely positioning the printing head 2 in relation to the coarse movement device 4 on the basis of the sensed position and/or orientation quantity PAG.

In detail, the position and/or orientation sensing device 13 comprises a tachymeter 15, in particular a laser tachymeter 15′. In particular, the position and/or orientation sensing device 13 is a tachymeter 15.

Further, the printing system 1 comprises an inertial sensor device 16. The inertial sensor device 16 comprises at least one inertial sensor 16′. The inertial sensor 16′ is arranged and designed on the printing head 2 and/or parallel robot 3 for sensing, in particular senses, an inertial quantity IG, in particular a dynamic inertial quantity, which determines a movement of the printing head 2 and/or parallel robot 3 in relation to the building environment BU of the printing system 1. The controlling device 14 is designed for controlling the parallel robot 3 for finely positioning the printing head 2 in relation to the coarse movement device 4 by linking the sensed position and/or orientation quantity PAG, which in particular was sensed at a low frequency fn and/or which arrives at the controlling device 14 in particular and/or with a time offset Δt, and the sensed inertial quantity IG, which in particular was sensed at a higher frequency fh and/or which arrives at the controlling device 14 in particular and/or with a smaller or no time offset Δt or without a time offset, to one another, in particular by means of an estimate, in particular by an observer BT; in particular, said controlling device links and controls as a result.

In the exemplary embodiment shown, the inertial sensor 16′ is arranged and senses where the position and/or orientation sensing device 13 senses. In other words, the inertial sensor 16′ has an identical target to the position and/or orientation sensing device 13.

Moreover, the printing system 1 comprises a chassis 17, in particular a truck-mounted building material pump 18 comprising the chassis 17, as shown in FIGS. 1 and 3. The chassis 17 carries the printing head 2, the parallel robot 3, and the coarse movement device 4.

Moreover, the printing system 1 comprises a building material pump 19, as shown in FIG. 4. The building material pump 19 is designed for conveying, in particular conveys, building material BS, in particular at least in part along the coarse movement device 4, in particular for the delivery of conveyed building material BS, out of the printing system 1.

In the exemplary embodiment shown, the controlling device 14 is designed for controlling, in particular controls, the printing head 2, the parallel robot 3, the coarse movement device 4, and/or the building material pump 19, in particular on the basis of data DBWT of the structural part BWT to be printed.

As an addition or alternative, the printing head 2, the parallel robot 3, the coarse movement device 4, the interface, the position and/or orientation sensing device 13, the inertial sensor device 16, and/or the building material pump 19 are designed, more particularly each designed, for interacting, in particular interact, with the controlling device 14.

Moreover, the printing head 2 is designed for shaping the strand ST of building material BS with a grain size KO or a maximal grain size of at least 2 mm, in particular at least 8 mm, and/or at most 50 mm.

As an addition or alternative, the parallel robot 3 has a payload 3TL of at least 10 kg and/or at most 3000 kg, in particular at most 500 kg.

As a further addition or alternative, the parallel robot 3 has a positioning accuracy 3PG of at least 50 mm and/or at most 0.1 mm, in particular at most 1 mm.

As a further addition or alternative, the parallel robot 3 has a range 3R of at least 10 mm, in particular at least 100 mm, and/or at most 1000 mm, in particular at most 500 mm.

As a further addition or alternative, the parallel robot 3 has a maximum speed 3vmax of at least 10 mm/s and/or at most 10 m/s.

As a further addition or alternative, the parallel robot 3 has a maximum acceleration and/or deceleration 3amax of at least 0.1 m/s² and/or at most 500 m/s².

As a further addition or alternative, the coarse movement device 4 has a payload 4TL of at least 50 kg and/or at most 5000 kg.

As a further addition or alternative, the coarse movement device 4 has a positioning accuracy 4PG of at least 500 mm and/or at most 10 mm.

As a further addition or alternative, the coarse movement device 4 has a range 4R of at least 10 m and/or at most 100 m.

As a further addition or alternative, the coarse movement device 4 has a maximum speed 4vmax of at least 10 mm/s and/or at most 2 m/s.

As a further addition or alternative, the coarse movement device 4 has a maximum acceleration and/or deceleration 4amax of at least 1 m/s² and/or at most 20 m/s².

Moreover, FIGS. 3, 4, and 6 show a use of the printing system 1 for forming the strand ST of building material BS for 3-D printing of a structural part BWT.

Moreover, FIG. 5 shows the structural part BWT made of formed strands ST of building material BS and 3-D printed by means of the printing system 1.

As the exemplary embodiments shown and discussed above make clear, the invention provides an advantageous printing system for forming a strand of building material for 3-D printing of a structural part, which printing system has improved characteristics. Moreover, the invention provides an advantageous use of such a printing system for forming a strand of building material for 3-D printing of a structural part.

1.-15. (canceled)

16. A printing system for forming a strand of building material for 3-D printing of a structural part, the printing system comprising:
a printing head;
a parallel robot; and
a coarse movement device,
wherein the printing head is configured for delivery of building material from the printing system and for shaping building material in order to form the strand of building material,
wherein the parallel robot comprises at least three robot arm devices for finely positioning the printing head in relation to the coarse movement device, with at least two robot arm devices closest to one another being offset from one another with an oblique angle of arc along a circumferential direction about a central axis of the parallel robot, and
wherein the coarse movement device is configured for a coarse movement of the parallel robot with the printing head.

17. The printing system as claimed in claim 16, further comprising:
a conveying hose,
wherein the conveying hose leads between the two closest robot arm devices offset from one another with the oblique angle of arc for guiding the building material, from the coarse movement device, to the printing head.

18. The printing system as claimed in claim 16,
wherein the parallel robot comprises exactly three robot arm devices, and/or wherein the oblique angle of arc is approximately 120°.

19. The printing system as claimed in claim 16,
wherein the parallel robot comprises electrical, hydraulic, and/or pneumatic-free drive devices, said drive devices being designed for driving the at least three robot arm devices.

20. The printing system as claimed in claim 16,
wherein the coarse movement device comprises a serial robot for coarse movement of the parallel robot.

21. The printing system as claimed in claim 20,
wherein the serial robot is a distribution boom for the coarse movement of the parallel robot at a boom tip of the distribution boom.

22. The printing system as claimed in claim 20,
wherein the serial robot comprises rotary joints, with axes of rotation of the rotary joints being parallel to one another.

23. The printing system as claimed in claim 16, further comprising:
an orientation device configured for orienting the coarse movement device in relation to a building environment of the printing system.

24. The printing system as claimed in claim 16,
wherein the printing head and/or the parallel robot are/is free from an inclination degree of freedom.

25. The printing system as claimed in claim 16, further comprising:
an interface for a position and/or orientation sensing device and/or the position and/or orientation sensing device, which is independent of the coarse movement device and/or external,
wherein the position and/or orientation sensing device is designed for sensing a position and/or orientation quantity which determines a position and/or an orientation of the printing head and/or parallel robot in relation to a building environment of the printing system; and
a controller,
wherein the controller is designed for controlling the parallel robot for finely positioning the printing head in relation to the coarse movement device based on the sensed position and/or orientation quantity.

26. The printing system as claimed in claim 25,
wherein the position and/or orientation sensing device comprises a tachymeter.

27. The printing system as claimed in claim 25,
wherein the position and/or orientation sensing device comprises a laser tachymeter.

28. The printing system as claimed in claim 25, further comprising:
an initial sensor device,
wherein the inertial sensor device comprises at least one inertial sensor, the inertial sensor being arranged and designed on the printing head and/or parallel robot for sensing an inertia which determines a movement of the printing head and/or parallel robot in relation to the building environment of the printing system,
wherein the controller is designed for controlling the parallel robot for finely positioning the printing head in relation to the coarse movement device by linking to one another the sensed position and/or orientation quantity, which was sensed at a low frequency and/or which arrives at the controller with a time offset, and the sensed inertia, which was sensed at a higher frequency and/or which arrives at the controller with a smaller or no time offset.

29. The printing system as claimed in claim 16, further comprising:
a truck-mounted building material pump comprising a chassis, wherein the chassis carries the printing head, the parallel robot, and the coarse movement device.

30. The printing system as claimed in claim 16, further comprising:
a building material pump, wherein the building material pump is designed for conveying building material at least in part along the coarse movement device for the delivery of conveyed building material out of the printing system.

31. The printing system as claimed in claim 16, wherein one or more of:
the printing head is designed for shaping the strand of building material with a grain size of at least 2 mm and/or at most 50 mm,
the parallel robot has a payload of at least 10 kg and/or at most 3000 kg,
the parallel robot has a positioning accuracy of at least 50 mm and/or at most 0.1 mm, in particular at most 1 mm,
the parallel robot has a range of at least 10 mm and/or at most 1000 mm,
the parallel robot has a maximum speed of at least 10 mm/s and/or at most 10 m/s,
the parallel robot has a maximum acceleration and/or deceleration of at least 0.1 m/s² and/or at most 500 m/s²,
the coarse movement device has a payload of at least 50 kg and/or at most 5000 kg,
the coarse movement device has a positioning accuracy of at least 500 mm and/or at most 10 mm,
the coarse movement device has a range of at least 10 m and/or at most 100 m,
the coarse movement device has a maximum speed of at least 10 mm/s and/or at most 2 m/s, or
the coarse movement device has a maximum acceleration and/or deceleration of at least 1 m/s² and/or at most 20 m/s².

32. A method of forming a strand of building material for 3-D printing of a structural part comprising utilizing a printing system as claimed in claim 16.
